(19) United States
(12) Patent Application Publication
(10) Pub. No.: US 2003/0145520 A1
(43) Pub. Date: Aug. 7, 2003

(54) Container for inhibiting degradation during plant transport

(76) Inventor: Nicolas Bazzani, Savannaa, GA (US)

Correspondence Address: DICKINSON WRIGHT, PLLC, Suite 800, 1901 L. St., NW, Washington, DC, 20036, US

(21) Appl. No.: 10/226,306

(22) Filed: Aug. 23, 2002

(30) Foreign Application Priority Data
Feb. 1, 2002 (CO) 02-007967

(51) Int. Cl. A01G 9/02

(52) U.S. Cl. 47/84

(57) ABSTRACT

The container of the present invention relates to a type of box for containing plant products, especially flowers, for transport, which includes an external box that contains an internal box, which is covered by a thermal wrapper applied by vacuum, with inserts at the ends of the box, which can be taken out of the box, and chemical compounds that prevent the deterioration of the plaint products caused by ethylene emanations and by humidity (caused by cold temperature) in a bag with cooling gel incorporated therein. This container eliminates the need for electromechanical cold chains for express deliveries of plant products.

### FIELD OF THE INVENTION

The present invention relates to the field of shipping containers for plants, and in particular, to a container for inhibiting degradation during plant transport.

### SUMMARY OF INVENTION

The present invention relates to a type of container or box for plant transport, especially flowers, whose interior layout allows perishable plant products (such as grains, vegetables, greens, flowers) to be kept unaltered during transport, such as up to 48 hours, and especially in the event of an express mail delivery when an attempt is made to eliminate the need for electromechanical cooling systems during transport.

The container preferably includes an adaptation of insulating wrappers in which the plant product is placed, wherein chemical ingredients can be added to control humidity and gas emissions which naturally occur in plants. In this aspect, the container of the present invention preferably includes a box that is specially covered, filled with the plant product under semi-vacuum conditions, wherein the box is sealed, and contained in another box as a reinforcing cover for land and air transportation, without the need for refrigeration and preservation chains.

### BRIEF DESCRIPTION OF THE DRAWINGS

To understand the invention, we refer to the following illustrations of the proposed container:

FIG. 1 shows the structure of the container and its basic elements; and

FIG. 2 shows a detail of the container containing the plant product.

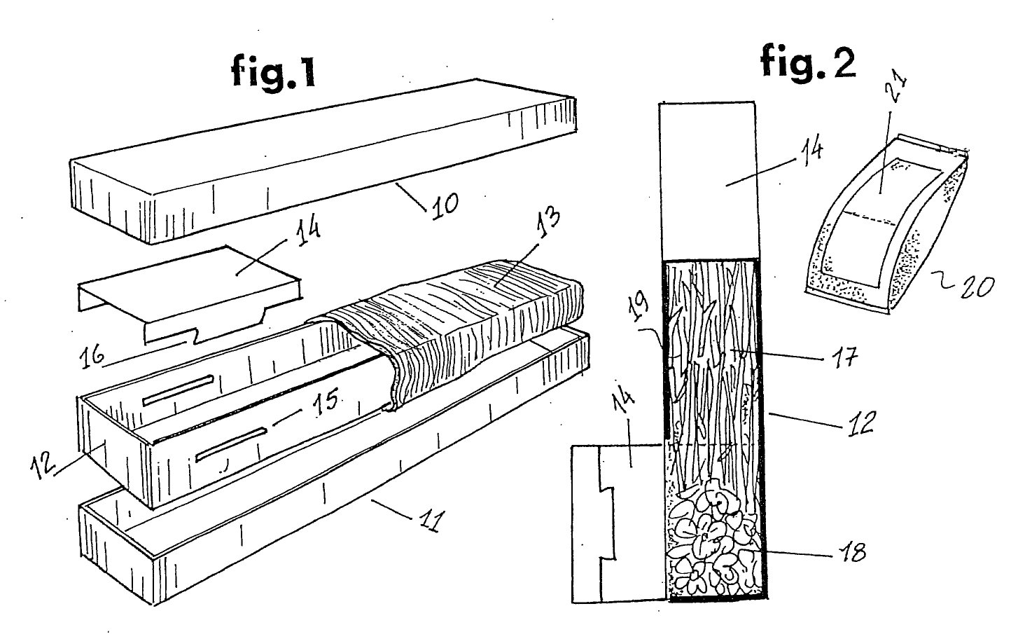

### DETAILED DESCRIPTION OF THE INVENTION

According to the Figures, the container preferably includes a cardboard wrapper or protection box having a lid 10 and a prismatic rectangular body 11, in which a second box 12 can be placed, adjusted to the volume of the external box, 10, 11. The boxes are preferably made of cardboard, but can be made of any conventional material.

The second box 12 is preferably wrapped in or covered (with the plant inside) by a thermal wrapper 13 made of a material suitable for thermal insulation. The thermal wrapper 13, which preferably covers the exterior of box 12, is preferably made up of a laminated sheet of closed cell polyethylene, covered by a sheet of aluminum paper—the type used in food bags. The polyethylene acts as an insulating element and aluminum paper acts as a heat refractive.

The interior box 12 is characterized by a prismatic-straight volume at whose ends there are preferably a pair of end cover inserts 14 with flaps 16 extending therefrom, which fit into corresponding holes or slots 15 in the wall of box 12, leaving an open space or zone 17 (FIG. 2) in the center of the box 12. The preferred embodiment shows two end cover inserts 14, one on each end, but it can be seen that one end cover insert 14 on only one end can be provided if desired.

When a plant product is placed inside the box 12 (FIG. 2), and the box 12 is covered by the thermal insulating layer 13, these plants are preferably laid out, in the case of flowers, so that the corolla and buds 18 are underneath one of the end cover inserts 14, with the stems 19 remaining in the open zone 17. This way, the plant product can be sealed inside the box 12, preferably applied by semi-vacuuming the wrapper 13, without affecting the corollas or buds 18 of the flowers which are protected by the one end cover insert 14. The additional end cover insert 14 on the other end allows additional flowers to be placed in box 12 in a reverse direction, if desired.

The plant products contained in the interior box 12, when scaled by vacuum in its thermal wrapper 13 (cool-wrap), is preferably accompanied by a bag 20 (placed inside box 12 and wrapper 13 with the plant product) filled with a cooling gel that has previously been hydrated for 5 or 6 hours to allow the cooling gel granules to inflate. Because the sealing is hermetic, the cooling gel can cause the humidity in the box 12 to be increased. And because humidity may further deteriorate the plant product with a risk of botritis or presence of fungi, the bag 20 is preferably accompanied by one or more absorbent pads 21, which are preferably provided with or adhered to the bag 20, to control humidity, and therefore, control deterioration.

In addition, the plant product is preferably preserved against possible deterioration caused by cold temperature. Plants naturally produce ethylene gas when exposed to cold temperature, and these gases may be absorbed by the plant itself, which, in the case of flowers, produces accelerated deterioration or degradation. This deterioration or degradation is preferably counteracted by the addition of another envelope inside box 12 with a component to control ethylene gas. The component is preferably based on an agglomerated powder which, when reacted with ethylene, oxidizes to produce manganese dioxide (MnO₂), which acts as a fertilizer and eliminates bacteria and fungi. This ethylene-controlling compound is a compliment to the cold temperatures created inside the box 12 without any electromechanical equipment for the wrapping model presented. Additionally, silica or calcium chloride may be added as dehumidifiers.

In the claims:

1. A container for protecting plant products against degradation during storage and transport, comprising:
a first exterior protection box,
a second box for containing the plant product capable of being positioned within the first protection box,
a thermal wrapping which can be applied on the exterior of said second box, and adapted to prevent degradation of the plant product by humidity and gases generated by the plant.

2. The container in accordance with claim 1, wherein said second box comprises a rectangular body with a pair of end inserts which can be secured on opposite ends of said second box.

3. The container in accordance with claim 2, wherein said end inserts can be secured to said second box using flaps extending therefrom, which are capable of being inserted into fitting slots located on lateral walls of the second box, wherein after being inserted, said end inserts leave a central open area within the second box.

4. The container in accordance with claim 1, wherein the thermal wrapping of the second box comprises a laminated sheet of closed cell polyethylene and aluminum paper.

5. The container in accordance with claim 1, wherein inside said second box, to prevent the degradation of the plant product contained therein, there is provided a component to control the production of ethylene gases emanating from the plant product.

6. The container in accordance with claim 1, wherein when the plant product is contained in the second box, the plant product is accompanied by a cooling gel in hydrated granules within a bag with absorbent elements or pads, which act as an anti-fungal element.

7. The container in accordance with claim 5, wherein when the plant product is contained in the second box, the plant product is accompanied by a cooling gel in hydrated granules within a bag with absorbent elements or pads, which act as an anti-fungal element.

8. The container in accordance with claim 1, wherein calcium chloride or silica is provided to prevent humidity in the second box.

9. The container in accordance with claim 6, wherein calcium chloride or silica is provided to prevent humidity in the second box.

10. The container in accordance with claim 1, wherein the thermal wrapping for the second box is applied under vacuum conditions.

11. The container in accordance with claim 2, wherein the thermal wrapping for the second box is applied under vacuum conditions with a layout of the plant products, seeking to protect them under the end inserts.

12. The container in accordance with claim 1, wherein said second box comprises a rectangular body with at least one protective cover insert which can be secured to said second box.

13. The container in accordance with claim 12, wherein said at least one protective cover insert comprises at least one end cover that can be secured to said second box using flaps extending therefrom, which are capable of being inserted into fitting slots located on lateral walls of the second box, wherein after being inserted, said at least one end cover leaves an open area within the second box.

14. A method of protecting plant products against degradation during storage and transport, comprising:
providing a first exterior protection box;
providing a second box for containing the plant product capable of being positioned within the first protection box; and
providing a thermal wrapping which can be applied on the exterior of said second box to prevent degradation of the plant product by humidity and gases generated by the plant.

15. The method in accordance with claim 14, wherein the method comprises providing one or two end inserts and securing them to said second box to protect said plant product in said second box from damage.

16. The method in accordance with claim 14, wherein the method comprises vacuum sealing said thermal wrapping onto said second box with said plant product inside.

17. The method in accordance with claim 14, wherein one or more components taken from the following group is placed inside said second box to prevent the degradation of the plant product contained therein:
a) a component to control the production of ethylene gases emanating from the plant product;
b) a cooling gel in hydrated granules within a bag;
c) absorbent elements or pads, which act as an anti-fungal element; and
d) calcium chloride or silica to prevent humidity in the second box.
